(19) United States
(12) Patent Application Publication
(10) Pub. No.: US 2010/0070862 A1
(43) Pub. Date: Mar. 18, 2010

(54) IN-PAGE EMBEDDABLE PLATFORM FOR MEDIA SELECTION AND PLAYLIST CREATION

(75) Inventors: Hadi Partovi, Seattle, WA (US); Nathaniel S. Brown, Seattle, WA (US); Steven Rider, Seattle, WA (US); Johanna Buck, (US); Seth W. Cousins, The Woodlands, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: iLike, Inc.

(21) Appl. No.: 12/555,704

(22) Filed: Sep. 8, 2009

Related U.S. Application Data
(60) Provisional application No. 61/191,398, filed on Sep. 9, 2008.

(51) Int. Cl. G06F 3/048; G06F 17/30

(52) U.S. Cl. 715/716; 715/760; 707/769; 707/E17.014

(57) ABSTRACT

An in-page embeddable platform provides media selection (for inclusion in a playlist or interactive feature) and playlist editing capabilities that may be accessed by a user from a 3^{rd} party web page. The platform allows a web site administrator to present an interactive playlist feature on a web site in manner that is integrated with the characteristics of the web page. Visitors to the web site may customize the playlist dynamically, without leaving the web site. An in-page user interface allows users to select new media, or to re-order or remove media from the playlist directly from the web page. The playlist may be edited or contributed to by any number of users, enabling collaborative media selection. The media-selection capability may be used directly in the context of selecting songs to add to a playlist, or it may be used in a standalone fashion.

### CROSS-REFERENCE TO RELATED APPLICATIONS

The present application claims priority from U.S. Provisional Patent Application No. 61/191,398, filed Sep. 9, 2008, the entire contents of which is hereby incorporated by reference for all purposes.

### BACKGROUND

The present invention is directed to systems, apparatus, and methods for the selection and playback of media files and, more specifically, to a system or platform that allows a user to select remotely stored media files and to create and edit a media file playlist by accessing a web page. The invention may be used to permit a user or group of users to select media stored on a web server to create a playlist, edit the playlist by adding, removing or re-ordering media content, and to make the playlist and associated media available to multiple users, such as members of a social network. The recipients of the playlist and associated media may similarly edit or reorganize the playlist and provide the revised playlist and the media associated with that playlist to other users. In particular, the invention enables a 3^{rd}-party web site to offer media-selection or dynamic-playlist editing functionality to its users by invoking the inventive system within the context of a web page hosted by the 3^{rd}-party.

As internet bandwidth increases and the majority of internet users have broadband access, music and video are becoming more popular types of content accessed over the internet. For example, many consumer-facing web sites incorporate interactive features that use music and video content as part of an advertisement or marketing presentation in order to enhance a user's experience. However, offering such functionality often requires a significant investment by the web site operator, advertiser, etc. To assist with this problem and make content more accessible, some internet content providers have offered in-page embeddable media playback modules (e.g., YouTube's video-player; music-players by iMeem, ProjectPlaylist, and Yahoo Music; and photo-slideshow players by Slide, RockYou, Yahoo Flickr, and Google's Picasa). These modules permit a media player to play back a pre-selected set of media content when the media player is accessed via a web page.

As noted, conventional media playback modules are hard-coded to present and playback a pre-defined list of media content (e.g., pre-specified songs, video, photos, etc.). This is typically accomplished by using a plugin object (e.g., Adobe's Flash or Microsoft's Silverlight plugins). A web page may provide access to video, music, or photos via a corresponding media playback module. Typically, a website creator provides a media playback module on a web page by visiting a central website (e.g., YouTube.com, iMeem.com, Slide.com, etc) to select media and to receive HTML “embed codes” in order to add the pre-selected media to a Web page. A module with the hard-coded, pre-selected media is then embedded into a separate web page for access by users visiting the web page.

For example, suppose a web site administrator wants to include a playlist of music on a web site. Web sites such as iMeem.com, ProjectPlaylist.com, RadioBlogClub.com, etc. offer a central web interface where the administrator may select a set of songs to create a playlist. These sites provide HTML code that the administrator may copy and paste into a web page, thereby enabling in-page playback of the specific list of songs that the administrator selected. However, a short-coming of the above approach is that the in-page playback is limited to the media content (video, music, images, playlist, etc.) that was selected by the web site administrator, and there is no ability for a user to modify the playback order or modify the content selected. Thus, existing systems do not enable 3^{rd}-parry web site administrators to provide certain functionality for users (such as dynamically-changing playlists or involving their userbase in the selection of media), specifically in the context of applying those functions to previously selected and ordered media content. Another disadvantage of the current approach is that the media display and playback interface is contained within the plugin object and uses the visual styles or format set by the module provider. This may result in a media playback interface, or playlist or media presentation that is incongruous with that of the web page from which the playback is accessed.

What is desired is a system and associated apparatus and methods for providing a user with the ability to select media content and to construct or edit a playlist from a web page. It is also desired to enable a user to overcome the inability to dynamically interact with, or change a hard-coded selection of media that is embedded in a web page. It is further desired to be able to dynamically adapt the display of the media or playlist to match the format or style of the containing web page, and to fit the number of media items displayed to the format of the web page. Embodiments of the present invention provide this and other benefits and overcome the disadvantages of presently available embeddable media playback devices and systems.

### SUMMARY

Embodiments of the present invention are directed to a system or platform for enabling one or more users to select media content and to create an associated playlist, with the selection of the content and creation or editing of a playlist being performed using an embeddable platform that is accessible via a third party web site. The playlist may be accessed by the user or users who created the playlist, or by others, such as the members of a defined group or social network. Those accessing the playlist may be granted a range of rights to edit the playlist, such as adding or removing content. The media content corresponding to the edited playlist may be accessed and played by visitors to the same or another web site. This permits members of a social network (for example) to generate content, and to use an in-page embedded playback module to provide access to the content, while enabling a web page or web site to include media selection and playlist-editing functions. By offering such a solution via standard page-embeddable modules, the present invention provides a developer platform for third parties to build interactive media features which integrate seamlessly with the existing design and format of a web site. The present invention allows a web site administrator to provide a user-editable playlist, thereby permitting visitors to the web site to select media to use in creating a new playlist, and to modify an existing playlist that is displayed on the site.

In some embodiments, the present invention is directed to a method of enabling a user to edit a playlist of media content, where the method includes presenting a web page to a user, the web page accessed using a browser and displayed to the user on a client device, receiving an indication that the user has activated code contained in the web page that specifies a playlist for display on the web page, accessing a remote data storage element to retrieve the selected playlist, presenting the retrieved playlist to the user on the web page, receiving an input from the user via the web page, the input corresponding to an operation to be performed on the playlist, performing the operation on the playlist, and after the operation is performed, storing the playlist in the remote data storage element.

In other embodiments, the present invention is directed to a method of enabling a user to select media and create a playlist, where the method includes presenting a web page to a user, the web page accessed using a browser and displayed to the user on a client device, receiving an indication that the user has activated a user interface element contained in the web page, in response, and without navigating away from the web page, presenting a user interface for display to the user, the user interface including an element which, when selected by a user, enables the user to select media content for use in a playlist, receiving an indication that the user has selected media content for use in a playlist, accessing a remote data storage element to retrieve an identifier associated with the selected media content, and providing the identifier associated with the selected media content to the web page.

In yet another embodiment, the present invention is directed to a system to enable a user to select media content for inclusion in a playlist and for editing a playlist using a web page, where the system includes a playlist data storage element storing a set of playlists, each playlist including a list of media content that is displayed for playback when the playlist is activated, the playlist data storage element remote from a user client device and accessed by the client device over a communications network, a media content data storage element storing the media content contained in each of the set of playlists, the media content data storage element remote from the user client device and accessed by the client device over the communications network, and a processor coupled to the playlist data storage element and to the media content data storage element, the processor configured to implement a process that includes receiving a request to display a playlist on the web page, the request generated by the activation of code embedded within the web page, in response, presenting a user interface to the user on the web page that displays the playlist and provides the user with one or more user interface elements to enable the user to perform an operation on the displayed playlist, receiving a selection of an operation that the user desires to perform on the displayed playlist, generating a display of the playlist on the web page after performance of the operation, and storing a record of the playlist after performance of the operation in the playlist data storage element.

In yet another embodiment, the present invention is directed to a system to enable a user to select media content from within a web page, where the system includes a media content data storage element storing the media content that the user may select from, the media content data storage element remote from the user client device and accessed by the client device over a communications network, and a processor coupled to the media content data storage element, the processor configured to implement a process that includes receiving a request to enable a user to select media content, the request generated in response to the activation of code embedded within the web page, in response to the request, presenting a user interface to the user on the web page that enables the user to browse or search the media content contained in the media content data storage element, receiving a selection of media content from the user, determining a media identifier associated with the selected media content, and providing the media identifier associated with the selected media content to the code embedded in the web page.

These and other advantages of the invention will be apparent to those of ordinary skill in the art by reference to the following detailed description and the accompanying drawings.

### BRIEF DESCRIPTION OF THE DRAWINGS

FIG. 1 is a functional block diagram illustrating an in-page embeddable platform for selecting media from a web page and managing a playlist generated from the selected media, in accordance with some embodiments of the present invention;

FIG. 2 is a functional block diagram illustrating an in-page embeddable platform for editing an existing playlist from a web page, in accordance with some embodiments of the present invention;

FIG. 3 is a flowchart illustrating a process for accessing a third party web site to select media content and/or edit a playlist, in accordance with some embodiments of the present invention;

FIG. 4 is a flowchart illustrating a method for invoking media-selection using an in-page embeddable platform, in accordance with some embodiments of the present invention;

FIG. 5 is a flowchart illustrating a method for editing an existing playlist using an in-page embeddable platform, in accordance with some embodiments of the present invention; and

FIG. 6 is a functional block diagram illustrating the components of a data processing or computing apparatus (such as a server or client device) that may be used to implement an embodiment of the present invention.

### DETAILED DESCRIPTION

Embodiments of the present invention are directed to a system or platform that may be embedded in a web page, and that enables a user to select media for inclusion in a playlist (or in a form of interactive content), or to edit a previously created playlist. The invention provides media content presentation and playback functions, and also provides editing capabilities for a media file playlist generated from the selected media. The invention may be accessed from a third-party web page, and the inventive platform allows a web site administrator to present an interactive or editable playlist feature on the web site. Visitors to the web site may play the content associated with the playlist and customize or modify the playlist dynamically, without leaving the web site. An in-page user interface allows users to select new media, or to re-order or remove media from a playlist directly from the web page. The playlist may be edited or contributed to by any number of users, enabling collaborative media selection. The media selection capability may be used directly in the context of selecting songs to add to a playlist, or it may be used in a standalone fashion. For example, the web site administrator or developer may use the media selection tool to enable a user to select media to send to another user, or to incorporate the media into a presentation accessible from the web site. The inventive system may be used with its associated apparatus and methods to enable a user to use a web page interface to select media content, create a playlist, or edit a pre-existing playlist, where the media content may include one or more of video, audio, images, or other suitable content.

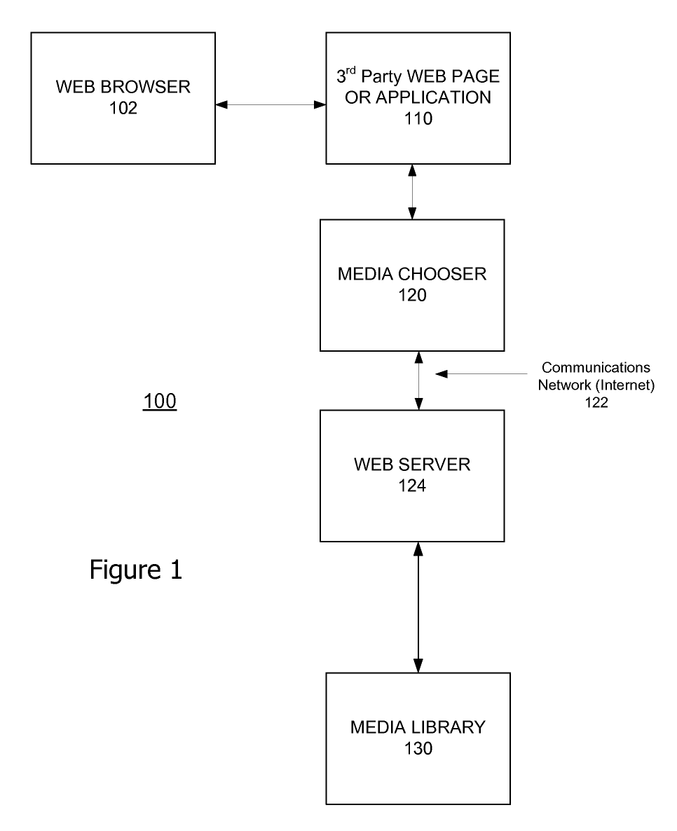

FIG. 1 is a functional block diagram illustrating an in-page embeddable platform 100 for selecting media from a web page and managing a playlist generated from the selected media, in accordance with some embodiments of the present invention. The platform includes a web browser 102 installed on a client computer, a third-party web page or application 110, a page-embeddable media chooser 120, a web server 124, and a media library 130. Media chooser 120 typically communicates with web server 124 using a suitable communications network (element 122), such as the Internet. Other elements may be included in the inventive platform without departing from the underlying concepts of the invention.

In the context of the present invention, use of the terminology “in-page embeddable platform” is intended to include, but not be limited to, suitable technologies and methods for permitting a 3^{rd} party web site administrator to extend the functionality of a particular web page via client-side code (e.g., using HTML, JavaScript, Actionscript, etc.) in order to provide a desired functionality, such as the ability to invoke dynamic media from a 1^{st} party. Thus, a visitor to a web page is enabled to invoke a user interface or application that is configured (by the web site administrator, using client-side code) to permit the user to select media content or edit a playlist. The media content or playlist is accessed from a remote server that is capable of communication and data transfer with the web page using a communications network, such as the Internet. For example, the user interface or application may be invoked by activation of a hyperlink placed on the web page, where activation of the hyperlink causes a web server to provide a page to the user's browser that provides a user interface that permits the user to access one or more of the functions of the inventive system.

In a typical use case, a user navigates to the 3^{rd}-party web page/application 110 via the web browser 102, and activates code at the webpage/application 110 that enables an in-page embedded media selection function in the form of media chooser 120. The media chooser 120 is invoked in response to the code activated at the 3^{rd} party web page/application 110, such as by user activation of a hyperlink or application presented on the web page, with the underlying code for media chooser 120 being delivered to the web-page from web server 124. The media chooser 120 presents a user interface at the web page/application 110 to allow a user to search and browse the media library 130 and to select a media item (e.g., a song, video, photo, etc.) from the media library 130. The selected media may be used to create a new playlist, added to an existing playlist, or incorporated into a presentation (such as an interactive video, etc.). Thus, the media chooser interfaces with the media library over the Internet (or another suitable communications network), communicating via a web-server that provides the relevant web-services to query the contents of the media library.

In order to enable the user to select the desired media content, a media library search or browse capability is provided. The user may utilize the search capabilities of the media chooser 120 by entering a query from the user interface. The query may take any suitable form, such as entry of keywords and one or more boolean operators, data for a specific category or field, etc. Media items that match the query are then displayed on the user interface for user selection. A browse function may be used to offer categories or lists of media to select from the user interface. The user interface may also display pre-selected media items for selection by the user, for example, personalized recommendations generated by any suitable recommendation process such as collaborative filtering, suggestions from other visitors to the web site, members of a group or social network, etc.

The media chooser 120 may be used to include a media item in a playlist, either a newly created playlist or in a previously created list. The media chooser 120 may also enable a user viewing a web page to select a media item for use in other ways, for example, to add a media item to a message or to a greeting card.

The media library 130 is a back-end media repository that offers internet-accessible media for playback or incorporation into a playlist. The web server 124 provides web-services that enable the presentation and operation of the search/browse user interface of the media chooser 120, which communicates with the web server via a suitable communications network, such as the Internet. The media library and the web server may run as separate or as combined elements (e.g., software components) on one or more individual server/computing devices.

In response to receiving the selection of a media item by a user, the media chooser 120 returns the identity (e.g., a media identifier) of the selected media item to the web page/application 110. The web page/application 110 may then invoke a media rendering object to display the selected media object for viewing and/or playback. The media rendering object may send the media identifier to the media library 130 to retrieve a display-ready version of the media or information regarding the media (e.g. preformatted Flash embed-code, HTML (or another suitable markup language) which may have CSS styling applied to match the design, format, or other characteristics of the containing site, i.e., web page 110). Alternatively, the web page/application 110 may store the media identifier for future access and playback.

An example of HTML and JavaScript code that may be used to invoke the media chooser 120, and to display the selected media is shown below:

<a href=“#” onclick=“invokeSongChooser({onSelected:
onSongSelected});”>Choose song</a>
<div id=“song2” />
<script>

// Called when the user selects a song
function onSongSelected(trackId, songName, artistName) {

// Optionally persist track id
var ajax = new Ajax( );
var params = {trackId:trackId};
ajax.post(“http://myserver.com/persist_track_id”, params);
// Display selected song
invokeDisplaySong({elId:“song2”, trackIds:trackId});
}

</script>

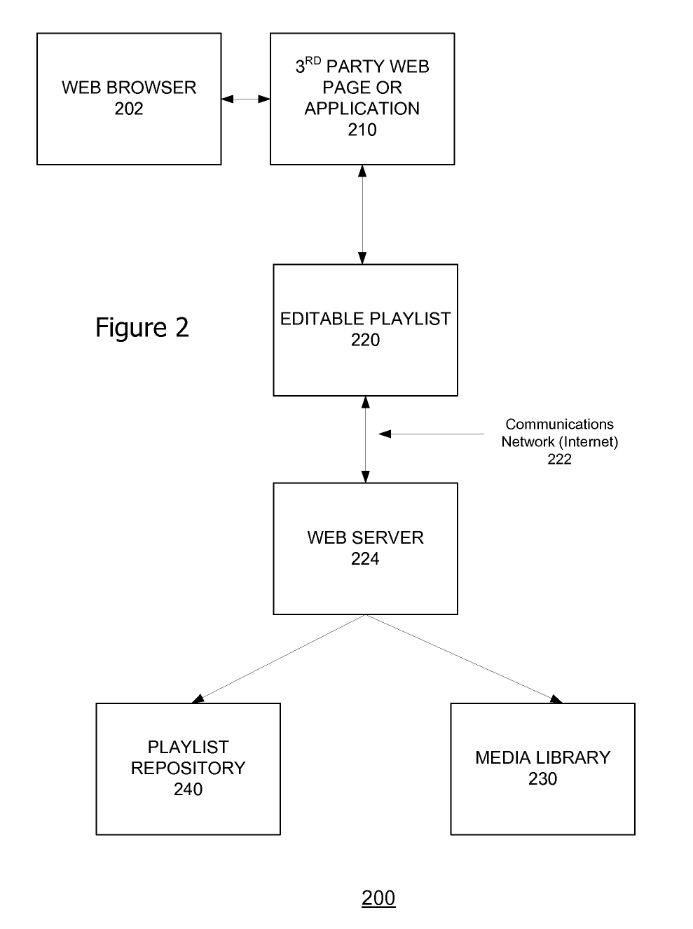

FIG. 2 illustrates an in-page embeddable platform 200 for editing an existing playlist from a web page, in accordance with some embodiments of the present invention. In some embodiments, the platform includes a web browser 202 installed on a client computer, a third-party web page or application 210, a page-embedded editable playlist 220, a web server 224, a media library 230, and a playlist repository 240. Web server 224 typically communicates with activated elements of web page or application 210 using a suitable communications network (element 222), such as the Internet.

In a typical use case, a user navigates to the 3^{rd} party web page/application 210 via the web browser 200 and activates code (e.g., a hyperlink or user interface element displayed on the page) that enables viewing and editing of an existing playlist 220 by the user. The editable playlist 220 is invoked in response to the code activated at the web page/application 210, where this code is delivered via web server 224. In some embodiments, the activated code or hyperlink specifies a particular playlist for editing, which may be identified by an identifying number, index, name, URL, etc. Thus, the web page may contain a link or other means of providing access to a specific playlist 220, where that playlist may be edited by a user.

Unlike conventional in-page embeddable playlists, the selection of media to be included in the editable playlist 220 of the present invention is not fixed. Further, the order in which selected media is presented is also not fixed or restricted to a pre-selected order. The media selected for inclusion in the playlist 220 is stored in the media library 230, with a record of the playlist being stored in playlist repository 240. Each playlist within the playlist repository 240 is identified by a unique playlist identifier. In some embodiments, the unique playlist identifier may serve to identify the area of the playlist repository 240 where the media identifiers included in the playlist 220 (or other playlists contained in playlist repository 240) are stored. In some embodiments, the playlist repository 240 may include a database or record of playlists, with each playlist indexed by a corresponding playlist identifier. Each playlist may be an ordered sequence of media identifiers, where each media identifier corresponds to a media item included in the playlist. The media identifier may take the form of a URL, an alphanumeric or numeric index to the media library 230, or another suitable format. When requested by a user, the playlist (i.e., a list indicating the contents and ordering of media content contained in the playlist) may be returned from the playlist repository in a display-ready format for inclusion on the page (e.g., Flash embed codes, or preformatted HTML with site-specific CSS styling applied, so that the display of the playlist is compatible with the formatting or other display characteristics of the web page), or it may be returned as an ordered list of media items which are formatted for display on the client device.

An in-page user interface allows users to perform one or more editing operations on the selected playlist (and, as a result on the media content specified by the playlist). These operations include adding media to the playlist, removing media from the playlist, or re-ordering the media contained in the playlist. A user may add media items to the playlist 220 by invoking the media chooser 130 (as described above with reference to FIG. 1). In addition, if displayed in edit-mode, the playlist display interface may provide a mechanism to remove or re-order media items. Modifications to the playlist made from the web interface are saved back to the playlist repository 240, and thus playlist 220 may be edited or contributed to by any number of users who visit the web page, enabling collaborative media selection for members of a group or social network, for example.

As noted, the web page/application 210 that invokes the playlist 220 does so by specifying the corresponding playlist identifier, referencing the playlist stored in the playlist repository 240. Thus, when the same unique identifier is used at a later time, the editable playlist 220 displays (and enables collaborative editing of) the same selection/order of media items.

In some embodiments, when a playlist is displayed at the web page/application 210, a read-request is made to the playlist repository 240 to access the selection/order of media items to display. When a playlist is edited from the web page/application 210, a write-request is made to the playlist repository 240 to update the media selection/order of the playlist.

The web page/application 210 that invokes the editable playlist 220 may also specify a display or operational/functionality mode (e.g., view, edit or add) that is granted to the user accessing the playlist. This may be done to control the ability of different users to modify or otherwise alter the playlist. For example, users to whom it is desired to grant different rights to modify the playlist may be directed to a different web page for accessing the playlist. The invoking web page/application 210 may be enabled to choose when to invoke each of these three (or other possible) modes when accessing the playlist. As an example mode, in “view” mode, the playlist 220 may be static, and only provide for playback functionality. In “edit” mode, the playlist 220 may be editable by the user (e.g., in the sense of reordering the list). In “add” mode, the user may be enabled to add media items to the playlist 220, but may not be enabled to reorder or remove media. As an example use case, the “add” mode may be used in collaborative situations, where one user or set of users are “editors”, and another user or set of users are “contributors”. Note that other allocations of playlist editing, media content addition, or media content removal rights among the different operational modes are possible, and are understood to fall within the scope of the present invention. For example, if the 3^{rd} party web page/application 210 is associated with a social network, then the 3^{rd} party web site developer/administrator may choose to let different people view or edit the playlist 220 depending on whether they are “friends” (or have a specified relationship with, or to the user) with the user who created the playlist 220, or are members of a group that has the appropriate access to view or edit the playlist. Note that in some embodiments, the decision as to which users receive the various possible permissions to view, edit, or add to a playlist are determined and managed by the 3^{rd} party web site administrator, who then designates the “mode” for the display/functionality of the playlist at the time when the playlist is invoked on the web page 210 by a user.

Existing systems (e.g., YouTube's video-player, iMeem's playlist player, etc.) enable a web site administrator or blogger to select a single video (e.g., from YouTube.com), or a specific playlist of music (e.g., from iMeem.com), in order to embed the selected media into a 3^{rd} party web site or blog. However, embodiments of the present invention allow a 3^{rd} party web site to offer an interactive playlist feature (with a pre-defined set of rights granted to a user), so that a visitor to the web site is able to customize the playlist dynamically without leaving the web site, thereby offering site visitors the ability to construct a custom playlist.

For example, an event/invitation web site (such as Evite.com) may use embodiments of the present invention to allow an invitation to include a guest-editable playlist for the planned event. A wedding-planning site may allow a bride and groom to collaboratively edit a wedding reception playlist online. A blogging web site (such as blogger.com) may allow blog creators to add a music or video playlist to their blog without having to visit a separate web site (such as YouTube or iMeem) to select the video or music. Similarly, bloggers may allow readers of the blog to add to, or edit items in the playlist without leaving the blog.

As an example, the functionality described above can be implemented by a hosting site using the following HTML code to invoke an editable playlist:

<div id=“playlist1” />
<script>

invokeDisplayPlaylist({elId:“playlist1”, playlistName:“p1”,

maxSongs:“15”, editMode:“edit”});
</script>

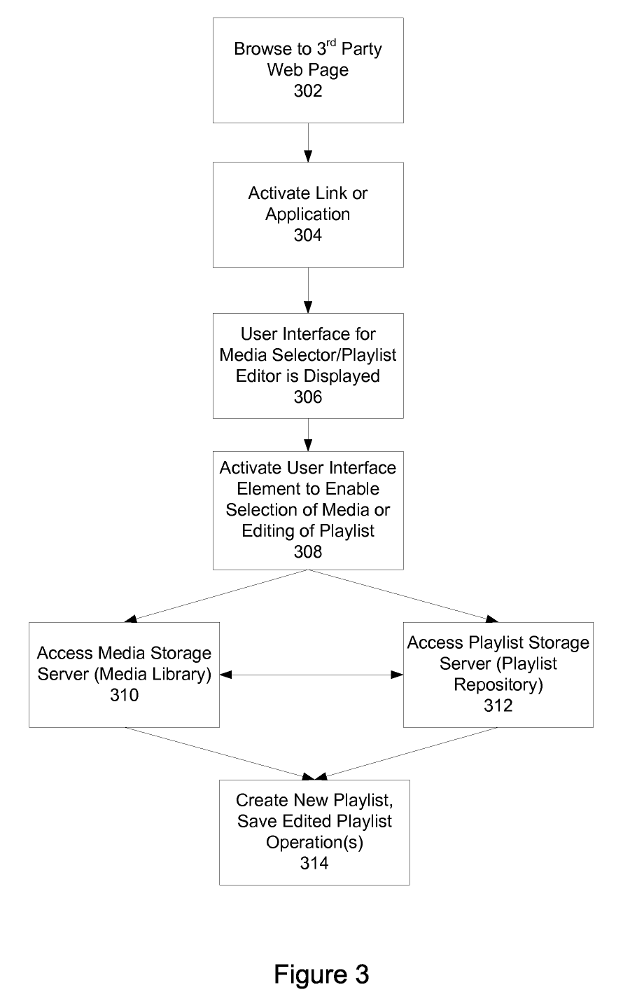

FIG. 3 is a flowchart illustrating a process for accessing a 3^{rd} party web site to select media content and/or edit a playlist, in accordance with some embodiments of the present invention. As shown in the figure, at stage 302 a user navigates to a 3^{rd} party web page, typically using a browser installed on the user's client device. The web page is typically identified by a URL, with the web page being displayed to the user in response to the user accessing the web page. The displayed web page may contain a hyperlink or other suitable user interface element that may be activated by a user. In response to a user activating a hyperlink or launching an application by selection of an appropriate user interface element (stage 304), a user interface is displayed to the user (stage 306). The user interface is configured to permit the user to select one or more operations, such as media selection or editing of a playlist (in accordance with any applicable rights or permissions granted to the user). As was described, the playlist editing operation is specific to an identified or specified playlist. A user then selects the desired operation, typically be activating the appropriate user interface element (stage 308). In some embodiments, the selected operation may be one of media selection (via the media chooser) or playlist editing. If the user selects the operation of media selection, the user may be enabled to access a media storage server or media library (stage 310), which as described may be a remote server containing the media content that may be selected using the media chooser module (and the associated user interface to enable browsing and/or searching the media content). If the user selects the operation of playlist editing for the specified playlist, the user may be enabled to access a playlist storage server or playlist repository (stage 312), which may be part of, or in communication with the media storage server or media library (as suggested by the arrow connecting stages 310 and 312). The playlist storage server or playlist repository may communicate with the media storage server or media library to access media identification data for incorporation into a playlist. After the user has created a new playlist or edited an existing playlist, the new or edited playlist may be “saved” by performing a suitable data write operation (stage 314).

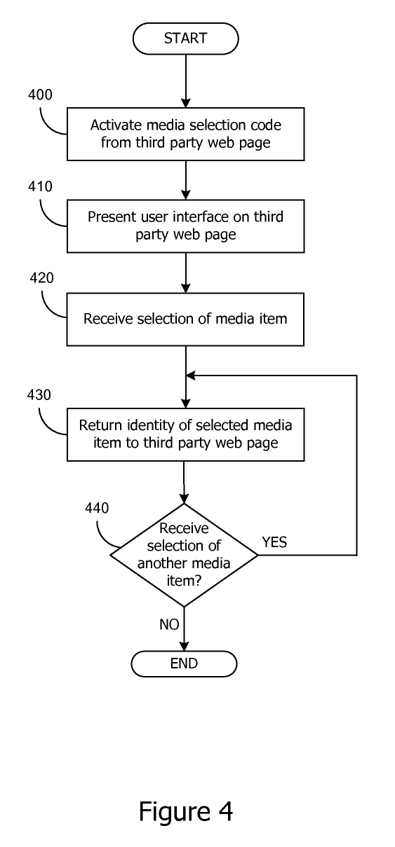

FIG. 4 is a flowchart illustrating a method for invoking media-selection using an in-page embeddable platform, in accordance with some embodiments of the present invention. As shown in the figure, code for selecting media is activated from a 3^{rd} party web page (stage 400). The 3^{rd} party web page may be a web site that supports at least one type of media file such as video files, audio files, or picture files. The web page may use the selected media items to add to a newly created or to a pre-existing playlist, or it may enable single-item media functionality (for example, allowing users to choose a single song to share with friends). The 3^{rd} party web administrator responsible for the web site includes code that may be used to invoke the media-selection object, which in turn allows the web page viewer to select media items from a media library via a search, browse, or other suitable form of interface, with the media-selection object then returning the corresponding media identifier back to the invoking web page.

A media-selection interface is delivered from the web server and presented on the 3^{rd} party web page in response to the code activation (stage 410). Typically, the media-selection interface provides a user with search and/or browse capabilities in order to identify and locate different media files stored in a media library that may be of interest to the user.

In response to identifying a media file that may be of interest to the user, the user is enabled to select a media item by interacting with the media-selection interface (stage 420) (i.e., the interface may receive a selection of a media item from the user as a result of the user providing a suitable user input). The media item may be a song, video, photo, or other suitable type of media content, etc. that the user may wish to include on the web page or as part of a playlist.

After selection of the media item, the identity of the selected media item is returned to the web page (stage 430). The identity of the selected media item may be a media identifier such as a URL or may be a unique numeric or alphanumeric index to data stored in the media library. The web page may store the media identifier for subsequent access and playback of the media content.

In some embodiments of the present invention, a determination may be made as to whether additional media items are selected (stage 440). If additional media items are selected, processing may be returned to stage 430; otherwise, processing may be terminated.

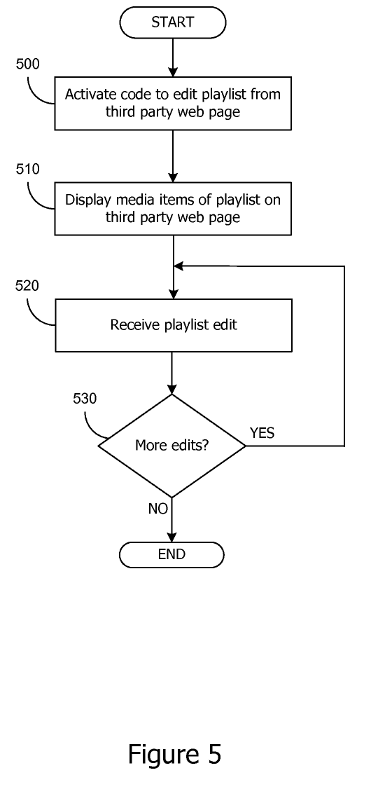

FIG. 5 is a flowchart illustrating a method for editing an existing playlist using an in-page embeddable platform, in accordance with embodiments of the present invention. In some embodiments, code for editing an existing playlist may be activated from a 3^{rd} party web page (stage 500). The 3^{rd} party web page may be a web site that supports at least one type of media file such as video files, audio files, or picture files. The playlist may include one or more of these different types of media, or other suitable types of media content. The 3^{rd} party web administrator responsible for the web site may include code for displaying a playlist on the web page in order to allow at least one user to view and optionally edit the playlist. The code that invokes the playlist object specifies the playlist that is displayed via a unique playlist identifier. The playlist identifier may be an URL, an alphanumeric or numeric index to the media library or may be another format that enables identification of data stored in the media library. A user viewing the web page may not automatically see a user interface to enable selection of different playlists, although such controls may be included at the host web site.

Once invoked, the playlist object uses a web service call to the playlist repository to retrieve an ordered list of media items included in the playlist, and the ordered list of media items is displayed to the user on the web page (stage 510). In some embodiments, the playlist may size itself dynamically depending on how many media items are present, and on the selected display mode for the web page or the selected playlist function mode. The playlist may be presented in a format that is compatible with the web page and the web page's formatting, color scheme, etc. As noted, the playlist may be displayed in different modes, depending on the playlist editing rights that are intended to be granted to a user, with those rights being specified by the 3^{rd} party code that invokes the playlist object. For example, in “view” mode, the playlist may be displayed immutably, as a list of songs. In “edit” or “add” mode, the playlist may be displayed along with user interface controls to enable a user to add media, remove media or re-order media in the playlist.

If a user is granted editing rights to a playlist, an edit to the playlist may be received (stage 520). The user may edit the playlist to add a media item, remove a media item, or to change the order of the media items in the existing playlist. After processing an edit, a determination may be made as to whether additional edits to the playlist are received (stage 530). If additional edits are received to the playlist, processing returns to stage 520; otherwise, processing may be terminated.

Once editing of a playlist is complete, the updated playlist information (i.e., the revised ordered list of media identifiers) is stored in the media repository or another suitable data storage element. In some embodiments, each individual edit may be immediately saved to the media repository. In other embodiments, all edits to the playlist may be saved when the viewer is finished editing the playlist.

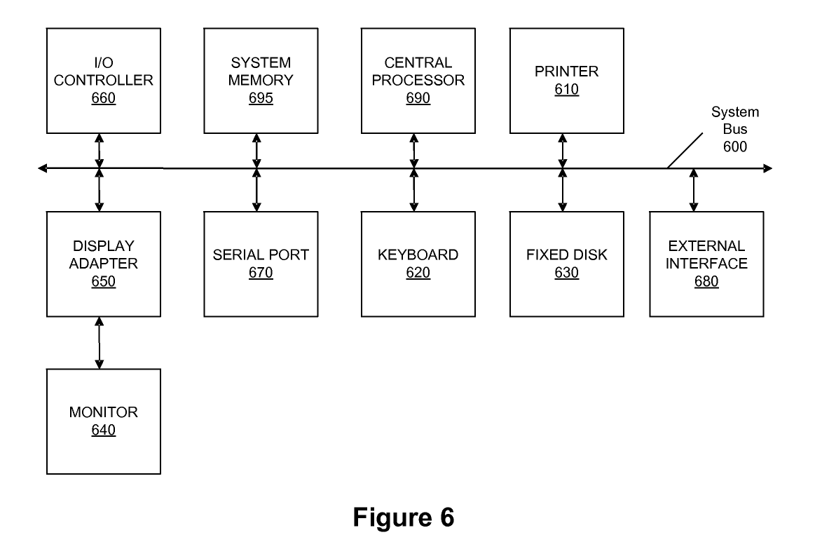

FIG. 6 is a functional block diagram illustrating the components of a data processing or computing apparatus (such as a server or client device) that may be used to implement an embodiment of the present invention. The elements of the computing apparatus illustrated in FIG. 6 may be used to implement the inventive processes, methods, or operations in whole or in part, and may be part of a web server or other computing apparatus. The data processing or computing apparatuses used to implement the present invention may utilize one or more of the illustrated components, and are not required to utilize all of the illustrated components. The subsystems shown in FIG. 6 are interconnected via a system bus 600. Additional subsystems such as a printer 610, keyboard 620, fixed disk 630 (or other memory comprising computer readable media), monitor 640, which is coupled to display adapter 650, and others are shown. Peripherals and input/output (I/O) devices, which couple to I/O controller 660, can be connected to the computer system by any number of means known in the art, such as serial port 670. For example, serial port 670 or external interface 680 can be used to connect the computer apparatus to a wide area network such as the Internet, a mouse input device, or a scanner. The interconnection via system bus allows the central processor 690 to communicate with each subsystem and to control the execution of instructions from system memory 695 or the fixed disk 630, as well as the exchange of information between subsystems. The system memory 695 and/or the fixed disk 630 may embody a computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented in the form of markup language, or as software code to be executed by a processor using any suitable computer language such as, for example, HTML, JavaScript, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method of enabling a user to edit a playlist of media content, comprising:
presenting a web page to a user, the web page accessed using a browser and displayed to the user on a client device;
receiving an indication that the user has activated code contained in the web page that specifies a playlist for display on the web page;
accessing a remote data storage element to retrieve the selected playlist;
presenting the retrieved playlist to the user on the web page;
receiving an input from the user via the web page, the input corresponding to an operation to be performed on the playlist;
performing the operation on the playlist; and
after the operation is performed, storing the playlist in the remote data storage element.

2. The method of claim 1, further comprising:
receiving an input from the user to activate the playback of media associated with the playlist; and
in response to receiving the input from the user, accessing the remote data storage element to retrieve the media associated with the playlist.

3. The method of claim 1, further comprising receiving an indication that the user has activated code contained in the web page that enables the user to perform one or more of a browsing or search operation on a set of playlists.

4. The method of claim 1, wherein accessing a remote data storage element to retrieve the selected playlist further comprises accessing the remote data storage element over a communications network.

5. The method of claim 4, wherein the communications network is the Internet.

6. The method of claim 1, wherein presenting the retrieved playlist to the user on the web page further comprises presenting the retrieved playlist in a manner that is compatible with a format or presentation style of the web page.

7. The method of claim 1, wherein the operation performed on the playlist is one or more of an operation to add media content to the playlist, remove media content from the playlist, or change an order of media content contained in the playlist.

8. The method of claim 7, wherein the operations that the user is enabled to perform on the playlist depend upon the identity of the user, and are determined by code contained in the web page.

9. A method of enabling a user to select media and create a playlist, comprising:
presenting a web page to a user, the web page accessed using a browser and displayed to the user on a client device;
receiving an indication that the user has activated a user interface element contained in the web page;
in response, and without navigating away from the web page, presenting a user interface for display to the user, the user interface including an element which, when selected by a user, enables the user to select media content for use in a playlist;
receiving an indication that the user has selected media content for use in a playlist;
accessing a remote data storage element to retrieve an identifier associated with the selected media content; and
providing the identifier associated with the selected media content to the web page.

10. The method of claim 9, further comprising enabling the user to create a playlist that includes the selected media content.

11. The method of claim 9, wherein the selected media content is one or more of video, audio, images, or text.

12. The method of claim 10, wherein data regarding the created playlist is stored in the remote data storage element.

13. The method of claim 9, wherein the user interface element which enables the user to select media content for use in a playlist enables the user to perform a browsing or searching operation on the media content stored in the remote data storage element.

14. The method of claim 13, further comprising:
querying the remote data storage element to identify search results, wherein the remote data storage element is queried in response to search terms received at the user interface;
displaying the search results on the user interface; and
enabling the user to select media content corresponding to at least one of the search results.

15. A system to enable a user to select media content for inclusion in a playlist and for editing a playlist using a web page, comprising:
a playlist data storage element storing a set of playlists, each playlist including a list of media content that is displayed for playback when the playlist is activated, the playlist data storage element remote from a user client device and accessed by the client device over a communications network;
a media content data storage element storing the media content contained in each of the set of playlists, the media content data storage element remote from the user client device and accessed by the client device over the communications network; and
a processor coupled to the playlist data storage element and to the media content data storage element, the processor configured to implement a process that includes
receiving a request to display a playlist on the web page, the request generated by the activation of code embedded within the web page;
in response, presenting a user interface to the user on the web page that displays the playlist and provides the user with one or more user interface elements to enable the user to perform an operation on the displayed playlist;
receiving a selection of an operation that the user desires to perform on the displayed playlist;
generating a display of the playlist on the web page after performance of the operation; and
storing a record of the playlist after performance of the operation in the playlist data storage element.

16. The system of claim 15, wherein the user client device includes a browser that is used to communicate with the processor, and further, wherein the communications network is the Internet.

17. The system of claim 15, wherein the operations that the user may select to perform on the displayed playlist include one or more of an operation to add media content to the playlist, remove media content from the playlist, or change an order of media content contained in the playlist.

18. The system of claim 17, wherein the operations that the user may select to perform on the playlist are specified by the code within the web page, and may depend on the identity of the user.

19. The system of claim 15, wherein the selected playlist is displayed on the web page in a manner that is compatible with a format or presentation style of the web page.

20. A system to enable a user to select media content from within a web page, comprising:
a media content data storage element storing the media content that the user may select from, the media content data storage element remote from the user client device and accessed by the client device over a communications network; and
a processor coupled to the media content data storage element, the processor configured to implement a process that includes
receiving a request to enable a user to select media content, the request generated in response to the activation of code embedded within the web page;
in response to the request, presenting a user interface to the user on the web page that enables the user to browse or search the media content contained in the media content data storage element;
receiving a selection of media content from the user;
determining a media identifier associated with the selected media content; and
providing the media identifier associated with the selected media content to the code embedded in the web page.

21. The system of claim 20, wherein the user client device includes a browser that is used to communicate with the processor, and further, wherein the communications network is the Internet.

22. The system of claim 20, wherein the request to enable the user to select media content is generated in response to the user activating a hyperlink on the web page.

23. The system of claim 20, wherein the media selected by the user is displayed on the web page in a manner that is compatible with a format or presentation style of the web page.
